(19) United States
(12) Patent Application Publication
(10) Pub. No.: US 2026/0141496 A1
(43) Pub. Date: May 21, 2026

(54) SYSTEM AND METHOD FOR ELIMINATING REFLECTED ARTIFACTS IN AN IMAGE

(71) Applicant: QUALCOMM Incorporated, San Diego, CA (US)

(72) Inventors: Sung Min KANG, Hwasung-Si (KR); Baek OH, Seoul (KR); Tae-June KIM, Uiwang-si (KR); Jingu KANG, Seoul (KR)

(21) Appl. No.: 18/950,593

(22) Filed: Nov. 18, 2024

(51) Int. Cl. G06T 5/77; G06T 3/40; G06V 40/16

(52) U.S. Cl. CPC G06T 5/77; G06T 3/40; G06V 40/172

(57) ABSTRACT

A device includes a memory configured to store first image data representing a first image captured by a first camera facing a first direction. The device also includes one or more processors coupled to the memory. The one or more processors are configured to obtain second image data representing a second image captured by a second camera facing a second direction that is opposite to the first direction and identify, based on the second image data, a region in the first image that includes one or more reflected objects. The one or more processors are configured to generate fill-in image data, which represents a fill-in image, based on the first image data and generate output image data, based on the first image data and the fill-in image data, that corresponds to the first image in which the region is replaced with the fill-in image.

### I. FIELD

The present disclosure is generally related to image processing to eliminate reflected artifacts in an image.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Reflective surfaces can sometimes cause unwanted reflected artifacts to appear in images captured by a camera. For example, a user may use the camera on the back of a mobile device to capture an image in the field of view of the camera. If a metallic or glass surface is located within the field of view of the camera, the image captured by the camera can include a reflection of the user and the mobile device depicted on the metallic or glass surface in the image. Although some mobile devices implement artificial intelligence (AI)-based image post-processing to remove depictions of light sources or blur some reflected artifacts within an image, such modifications to the image can be insufficient to remove an unwanted reflected artifact from an image. Additionally, cloud-based services can provide some blurring or image alteration, but users may be unwilling to share personal images due to concerns over privacy and data security associated with the cloud-based services.

### III. SUMMARY

According to one embodiment of the present disclosure, a device includes a memory configured to store first image data representing a first image captured by a first camera facing a first direction. The device also includes one or more processors, coupled to the memory. The one or more processors are configured to obtain second image data representing a second image captured by a second camera facing a second direction that is opposite to the first direction. The one or more processors are also configured to identify, based on the second image data, a region in the first image that includes one or more reflected objects. The one or more processors are configured to generate fill-in image data based on the first image data. The fill-in image data represents a fill-in image. The one or more processors are also configured to generate output image data, based on the first image data and the fill-in image data, that corresponds to the first image in which the region is replaced with the fill-in image.

According to another embodiment of the present disclosure, a method includes obtaining, by a device, first image data representing a first image captured by a first camera facing a first direction. The method also includes obtaining, by the device, second image data representing a second image captured by a second camera facing a second direction that is opposite to the first direction. The method includes identifying, by the device and based on the second image data, a region in the first image that includes one or more reflected objects. The method also includes generating, by the device, fill-in image data based on the first image data. The fill-in image data represents a fill-in image. The method includes generating, by the device, output image data, based on the first image data and the fill-in image data, that corresponds to the first image in which the region is replaced with the fill-in image.

According to another embodiment of the present disclosure, a non-transitory computer-readable medium stores instructions that are executable by one or more processors to cause the one or more processors to obtain first image data representing a first image captured by a first camera facing a first direction. The instructions also cause the one or more processors to obtain second image data representing a second image captured by a second camera facing a second direction that is opposite to the first direction. The instructions cause the one or more processors to identify, based on the second image data, a region in the first image that includes one or more reflected objects. The instructions also cause the one or more processors to generate fill-in image data based on the first image data. The fill-in image data represents a fill-in image. The instructions cause the one or more processors to generate output image data, based on the first image data and the fill-in image data, that corresponds to the first image in which the region is replaced with the fill-in image.

According to another embodiment of the present disclosure, an apparatus includes means for obtaining first image data representing a first image captured in a first direction. The apparatus also includes means for obtaining second image data representing a second image captured in a second direction that is opposite to the first direction. The apparatus includes means for identifying, based on the second image data, a region in the first image that includes one or more reflected objects. The apparatus also includes means for generating fill-in image data based on the first image data. The fill-in image data represents a fill-in image. The apparatus includes means for generating output image data, based on the first image data and the fill-in image data, that corresponds to the first image in which the region is replaced with the fill-in image.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system including a device operable to eliminate reflected artifacts in an image, in accordance with one or more aspects of the present disclosure.

FIG. 2 is a diagram of an example of capturing images using multiple cameras facing in different directions for use in generating an output image without a reflected artifact, in accordance with one or more aspects of the present disclosure.

FIG. 3 is a diagram of an example of image processing operations performed to eliminate reflected artifacts in an image, in accordance with one or more aspects of the present disclosure.

FIG. 4 is a diagram of an example of an integrated circuit operable to eliminate reflected artifacts in an image, in accordance with some examples of the present disclosure.

FIG. 5 is a diagram of a mobile device operable to eliminate reflected artifacts in an image, in accordance with some examples of the present disclosure.

FIG. 6 is a diagram of a wearable electronic device operable to eliminate reflected artifacts in an image, in accordance with some examples of the present disclosure.

FIG. 7 is a diagram of a camera operable to eliminate reflected artifacts in an image, in accordance with some examples of the present disclosure.

FIG. 8 is a diagram of a first example of a vehicle operable to eliminate reflected artifacts in an image, in accordance with some examples of the present disclosure.

FIG. 9 is a diagram of a second example of a vehicle operable to eliminate reflected artifacts in an image, in accordance with some examples of the present disclosure.

FIG. 10 is a diagram of an example of a method of eliminating reflected artifacts in an image, in accordance with some aspects of the present disclosure.

FIG. 11 is a block diagram of an illustrative example of a device that is operable to eliminate reflected artifacts in an image, in accordance with one or more aspects of the present disclosure.

### V. DETAILED DESCRIPTION

The present disclosure provides systems, apparatus, methods, and computer-readable media for eliminating reflected artifacts (e.g., objects, faces, etc.) in an image. Aspects disclosed herein enable a device, such as a smart phone that includes two cameras, to capture images using both of the cameras and, based on the captured image data, generate an output image that represents an image in which a region with one or more reflected artifacts is replaced by a fill-in image. For example, the device may include a first camera (e.g., a rear-facing camera) facing a first direction and a second camera (e.g., a front-facing camera) facing a second direction that is different than the first direction. In this example, the device obtains first image data that represents a first image captured by the first camera and second image data that represents a second image captured by the second camera. As a particular example, if a user of the device is using the first camera to capture a first image that includes a metal expresso machine (e.g., an object having a reflective surface) within the field of view (FOV), there may be reflections of the user, the device, or other objects behind or surrounding the user within the reflective surface of the expresso machine in the first image. Accordingly, the device may also capture a second image using the second camera that faces the opposite direction of the first camera in order to capture the various artifacts that are reflected in the first image, such as in this example the user who is holding the device when the first image is captured. Although the first image data and the second image data are described above as being captured by the cameras, in some other embodiments, the first image data, the second image data, or both, may be obtained from another source, such as from a memory of the device or from another device (e.g., via wireless communication).

After obtaining the first image data and the second image data, the device may optionally perform image processing on the first image data, the second image data, or both, such as to resize one or both of the images or to perform one or more image correction options on one or both of the images based on differences in FOV, focal length, etc., between the first camera and the second camera. After the optional image processing, the device identifies, based on the second image data, a region in the first image that includes one or more reflected objects. In some embodiments, the device generates a segmentation mask based on the second image data, and the identification of the region in the first image is based on a comparison of the segmentation mask and the first image data. Additionally, or alternatively, the device may perform one or more object detection operations, one or more facial recognition operations, or both, to identify common objects or faces in the first and second images. After identifying the region in the first image, the device generates fill-in image data that represents a fill-in image. For example, the first image data (e.g., corresponding to a remainder of the first image with the region removed or corresponding to an entirety of the first image) may be input to a trained artificial intelligence (AI) image generator (e.g., a generative AI model) that is configured to generate the fill-in image data based on pixels of the first image. Using the fill-in image data and the first image data, the device generates an output image (e.g., output image data) that corresponds to the first image in which the region is replaced with the fill-in image. In the particular example described above, the output image includes an image of the expresso machine in which the surface of the expresso machine is modified (e.g., based on infilling by the trained AI image generator) such that the surface of the expresso machine no longer appears reflective and the reflection of the user (e.g., the reflected artifact) is eliminated. The output image may be displayed to the user, and optionally the user may be prompted for acceptance of the output image for storage at the memory or for transmission to another device.

Particular embodiments of the subject matter described in this disclosure can be implemented to realize one or more of the following potential technical advantages. In some aspects, the present disclosure provides techniques for on-device image processing that eliminate reflected artifacts within an image, that improve user experience, and that preserve user privacy. For example, as compared to other image processing techniques that may blur or adjust lighting of user-selected objects in images, the system and method described herein enable a device to accurately identify reflected objects and to eliminate the objects by replacing them with fill-in image content. This can improve the look of the image by making it more difficult for a viewer to recognize that an image has been modified, as compared to blurring or adjusting lighting in a region of the image. Additionally, by employing a trained AI image generator stored at the device, the device performs on-device image processing and modification that does not share the user's private images with other parties, thereby preserving user privacy as compared to sending the images for off-device modification, such as to a cloud-based image modification service.

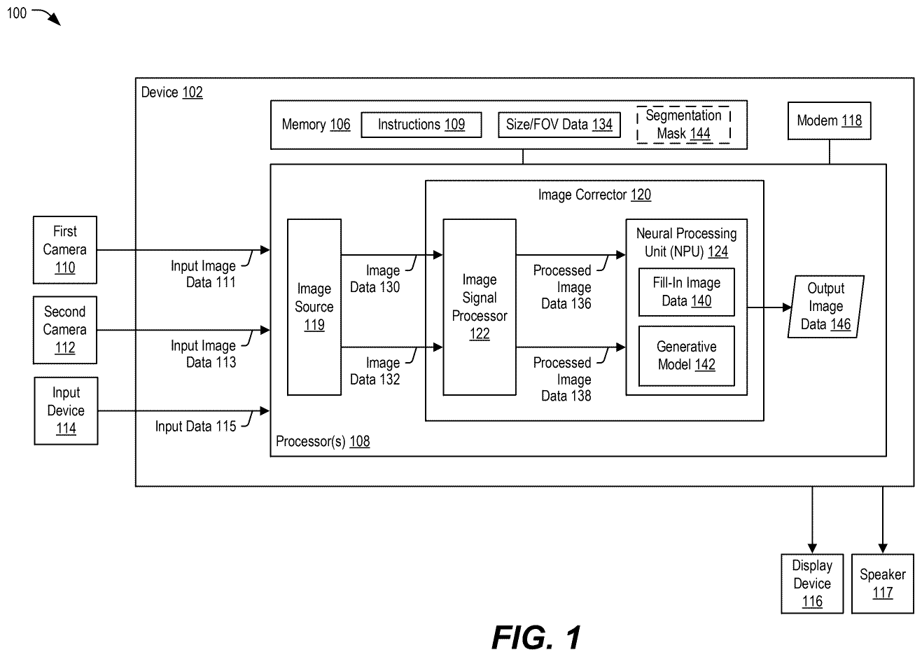

Particular aspects of the present disclosure are described below with reference to the drawings. In the description, common features are designated by common reference numbers. As used herein, various terminology is used for the purpose of describing particular embodiments or examples only and is not intended to be limiting of embodiments or examples. For example, the singular forms “a,” “an,” and “the” are intended to include the plural forms as well, unless the context clearly indicates otherwise. Further, some features described herein are singular in some examples and plural in other examples. To illustrate, FIG. 1 depicts a device 102 including one or more processors (“processor(s)” 108 of FIG. 1), which indicates that in some examples the device 102 includes a single processor 108 and in other examples the device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an embodiment, and/or an aspect, and should not be construed as limiting or as indicating a preference or a preferred embodiment. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some embodiments, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some embodiments, a model may be continuously, periodically, or occasionally updated, in which case training time and runtime may be interleaved or one version of the model can be used for inference while a copy is updated, after which the updated copy may be deployed for inference.

In some embodiments, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system 100 including a device 102 operable to eliminate reflected artifacts in an image, in accordance with one or more aspects of the present disclosure. The device 102 includes, or is coupled to, a memory 106, one or more processors 108 (collectively referred to herein as the “processor 108”), a first camera 110 (e.g., an image sensor), a second camera 112, an input device 114, a display device 116, a speaker 117, and a modem 118. The memory 106 may include one or more memory devices, such as a single memory device or multiple different memory devices (of the same type or of different types). The memory 106 is configured to store instructions 109, size/field of view (FOV) data 134, and optionally, a segmentation mask 144.

The size/FOV data 134 can include or indicate an image size associated with the first camera 110, an image size associated with the second camera 112, FOV measurements or parameters associated with the first camera 110, FOV measurements or parameters associated with the second camera 112, a focal length associated with the first camera 110, a focal length associated with the second camera 112, other data or information indicating the image size or FOV parameters associated with the first camera 110 or the second camera 112, or a combination thereof. Additionally, or alternatively, the size/FOV data 134 can indicate differences in image sizes associated with the first camera 110 and the second camera 112, differences in FOVs associated with the first camera 110 and the second camera 112, differences in focal lengths associated with the first camera 110 and the second camera 112, or a combination thereof. The segmentation mask 144 represents a mask that is generated by analyzing and processing image(s) captured by the second camera 112, such as by segmenting the foreground from the background, and is used to identify regions in image(s) captured by the first camera 110 that include reflected artifacts (e.g., reflected objects, reflected faces, etc.). The segmentation mask 144 is described as optional (and illustrated with a dashed line) because, in some embodiments, the device 102 generates the segmentation mask 144 and the segmentation mask 144 may be stored in the memory 106. In other embodiments, the device 102 does not generate the segmentation mask 144. In some examples, the memory 106 further includes or stores the instructions 109 that, when executed by the processor 108, cause the processor 108 to perform one or more operations as described herein. In some examples, the memory 106 stores other information or data, such as fill-in image data, output image data, other image data or video data, or a combination thereof.

The processor 108 includes an image corrector 120 that includes an image signal processor 122 and a neural processing unit (NPU) 124. Each of the image corrector 120, the image signal processor 122, the NPU 124, or a portion thereof, may be implemented by the processor 108 executing instructions (e.g., software), dedicated hardware (e.g., circuitry), a combination thereof. In FIG. 1, the device 102 (e.g., the processor 108) is coupled to one or more image sources 119 (collectively referred to herein as the “image source 119”). In some embodiments, the image source 119 (e.g., one or more image capture devices or image storage devices) is integrated within the device 102. For example, the image source 119 can include images (e.g., image data), video files (e.g., video data), media files (e.g., media data), or the like, stored in the memory 106 of the device 102. As another example, the image source 119 can include the first camera 110, the second camera 112, or both, integrated within or coupled to the device 102. As another example, the image source 119 can include the modem 118 that provides image data that is received from a remote device, such as a server, that is communicatively coupled to the device 102.

The image signal processor 122 is configured to perform image processing on image data received from the image source 119, such as image data 130 that corresponds to a first image and image data 132 that corresponds to a second image. For example, the image signal processor 122 may perform resizing operation(s), FOV correction operation(s), segmentation operations, object recognition operations, facial recognition operations, or a combination thereof, on the image data 130 and the image data 132 to generate processed image data 136 and/or processed image data 138, respectively. In some embodiments, the operations performed by the image signal processor 122 may harmonize a size, FOV parameters, other formatting, or the like, to the extent possible between the image data 130 and the image data 132.

The NPU 124 is configured to perform operations for identifying region(s) within image(s) that contain reflected artifacts and for generating image data to be “filled in” or “in-filled” to replace the regions containing the reflected artifacts. For example, the image signal processor 122 may be configured to generate fill-in image data 140 for use in generating output image data 146 that represents an output image in which a portion of an original image represented by the processed image data 136 is replaced with a fill-in image that appears to substantially match the original image. To illustrate, the fill-in image data 140 may represent image content having the same size as an identified region in the first image and for which pixels have similar values to pixels in the identified region, or surrounding region(s), that are not part of the reflected objects. In some aspects, the NPU 124 includes or is configured to operate as an artificial intelligence (AI) image generator (e.g., a generative AI model). For example, the NPU 124 may include (or have access to) a generative model 142 that is trained to generate new image content based on input images, input commands, or a combination thereof.

The first camera 110 is configured to capture one or more images or video and generate corresponding image or video data, and the second camera 112 is configured to capture one or more images or video and generate corresponding image or video data. For example, the first camera 110 may be configured to generate input image data 111 that represents a first image, and the second camera 112 may be configured to generate input image data 113 that represents a second image. The first camera 110 faces a first direction, and the second camera 112 faces a second direction that is opposite to the first direction. For example, the first camera 110 may be a rear-facing or back-facing camera that is integrated in a back side of the device 102, and the first camera 110 may be a front-facing camera that is integrated in a front side of the device 102.

The input device 114 includes an interface that enables a user to provide a user input, and the input device 114 is configured to generate input data 115 based on the user input. For example, the input device 114 may include a keypad, a touchscreen, a microphone, a camera, or another user input device. The input data 115 represents the user input provided to the device 102. In some examples, as further described herein, the input data 115 may represent selection of an object in an image, selection of one or more images for which reflected objects are to be eliminated, selection of one or more images to use in eliminating the reflected objects, selection of a storage location or target for output images, or a combination thereof.

The modem 118 is coupled to the processor 108 and is configured to transmit data to another device, receive data from another device, or both. For example, the data received by the modem 118 may include the input image data 111 (e.g., if the cameras 110, 112 are external to the device 102), the input image data 113, the size/FOV data 134, the segmentation mask 144, the generative model 142 (or parameters and/or hyperparameters associated with the generative model 142), or a combination thereof. As another example, the data transmitted by the modem 118 may include the output image data 146, the fill-in image data 140, or a combination thereof.

The processor 108 is also coupled to the display device 116 and the speaker 117. The display device 116 is coupled to the processor 108 and is configured to output one or more images or video in which reflected objects are eliminated and replaced with fill-in image content. For example, the display device 116 may be configured to display one or more output images based on the output image data 146. In some examples, the display device 116 includes a display screen, a monitor or television, a projector, or a combination thereof. The speaker 117 is coupled to the processor 108 and is configured to output audio. In some embodiments, the audio output by the speaker 117 is associated with the output image data 146. For example, if the output image data 146 includes frames of video or other multimedia, the speaker 117 may output audio of the video or other multimedia.

The first camera 110, the second camera 112, the input device 114, the display device 116, the speaker 117, or a combination there may be coupled to or integrated within the device 102. Although the device 102 is described as being coupled to or including the first camera 110, the second camera 112, the input device 114, the display device 116, the speaker 117, and the modem 118, in other embodiments, one or more of these elements are optional, and in such embodiments, the device 102 may not include or be coupled to the first camera 110, the second camera 112, the input device 114, the display device 116, the speaker 117, the modem 118, or a combination thereof.

In some embodiments, a device (e.g., the device 102) includes a memory (e.g., the memory 106) configured to store first image data (e.g., the image data 130) representing a first image captured by a first camera (e.g., the first camera 110) facing a first direction. The device also includes one or more processors (e.g., the processor 108), coupled to the memory. The one or more processors are configured to obtain second image data (e.g., the image data 132) representing a second image captured by a second camera (e.g., the second camera 112) facing a second direction that is opposite to the first direction. The one or more processors are also configured to identify, based on the second image data, a region in the first image that includes one or more reflected objects. The one or more processors are configured to generate fill-in image data (e.g., the fill-in image data 140) based on the first image data. The fill-in image data represents a fill-in image. The one or more processors are also configured to generate output image data (e.g., the output image data 146), based on the first image data and the fill-in image data, that corresponds to the first image in which the region is replaced with the fill-in image.

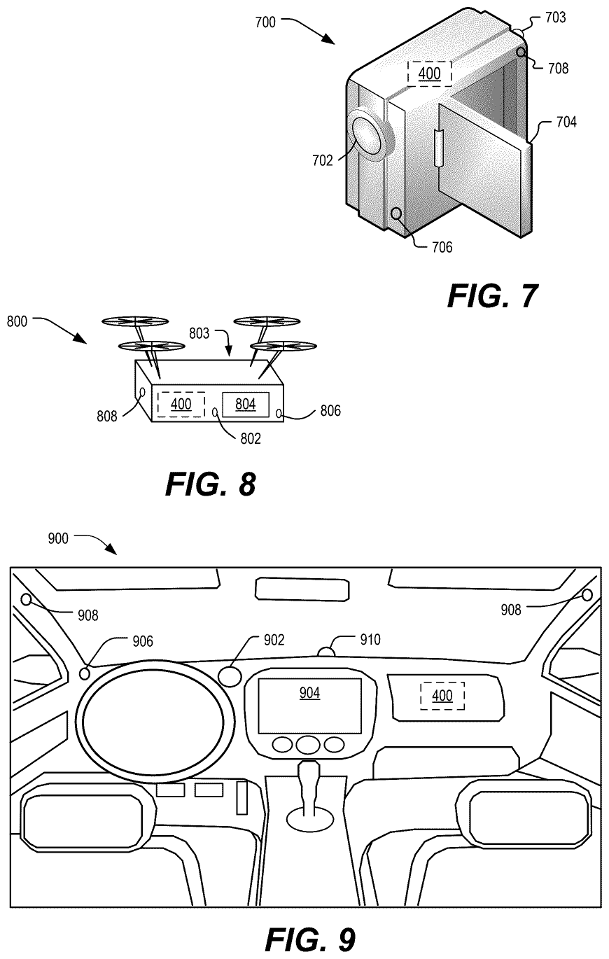

In some examples, the device 102 corresponds to or is included in one of various types of devices, such that the processor 108 can be integrated in multiple types of devices. In an illustrative example, the processor 108 is integrated in a wearable device, such as a wearable electronic device as depicted in FIG. 6, or another wearable device. In another illustrative example, the processor 108 is integrated in a mobile device (a mobile phone or a tablet) as depicted in FIG. 5, a camera as depicted in FIG. 7, a vehicle as depicted in FIG. 8 or FIG. 9, a computer or a server, or another system or device.

During operation of the system 100, a user of the device 102 may utilize the first camera 110 (e.g., the back-facing camera facing in the first direction) to capture a first image of a scene that includes a reflective surface. The first camera 110 may generate the input image data 111 that represents the first image, and the first image may include one or more reflected artifacts depicted on the reflective surface in the image. As an illustrative example, the first image may include reflections of the user and the device 102 depicted in the reflective surface of the scene. The user may view the first image in the display device 116 and decide to perform a reflection removal process, such as by providing a user input (e.g., represented by the input data 115) that indicates an affirmative selection of the reflection removal process. Alternatively, the device 102 may be programmed to automatically perform the reflection removal process or to perform the reflection removal process upon one or more trigger conditions being detected.

To eliminate the reflected artifacts in the first image, the user may utilize the second camera 112 to capture a second image of the user looking at the device 102. In some examples, the user may initiate the reflection removal process that causes the second camera 112 to capture the second image at least partially concurrently with, or shortly thereafter, capture of the first image by the first camera 110 (e.g., based on the input data 115 indicating to perform the procedure). Alternatively, the user can browse images stored at the memory 106 and, upon seeing one or more images (e.g., the first image) that include unwanted reflected artifacts, the user can initiate the reflection removal process to cause the second camera 112 to capture the second image, which can occur during a later time period (e.g., minutes, hours, days, months, or years later) than capture of the first image. For example, the reflection replacement process may be incorporated into a photo library application executed by the processor 108.

Although the second image is described as being captured during a later time period, and by the same device, as the first image, in other examples, the first image, the second image, or both, may be obtained from other sources. For example, the first image may be stored at the memory 106, at another device, in the cloud, etc., and the first image may have been captured by a different device than the device 102 (e.g., if the device 102 captured the second image). In such an example, the reflection removal process may prompt the user of the device 102 to capture the second image using the second camera 112 of the device 102. As another example, the user of the device 102 may capture the first image by utilizing the first camera 110, and the second image may be selected from images stored at the memory 106, at a server, in the cloud, etc. In some examples, the processor 108 may perform facial recognition on the first image to determine whether the user's face is included in the first image, and if the user's face appears in the first image, the device 102 may prompt the user to capture the second image as part of the reflection removal process.

The image corrector 120 obtains the image data 130 and the image data 132 from the image source 119 for processing to perform the reflection removal process. For example, the image data 130 may include or correspond to the input image data 111 generated by the first camera 110, a first image stored in the memory 106, or a first image received from another device. Similarly, the image data 132 may include or correspond to the input image data 113 generated by the second camera 112, a second image stored at the memory 106, or a second image received from another device.

After obtaining the image data 130 and the image data 132, the image signal processor 122 may perform one or more image processing operations on the image data 132 to match one or more characteristics of the image data 132 to corresponding characteristics of the image data 130. For example, the image processing operations can include one or more resizing operations based on size information indicated by the size/FOV data 134, one or more FOV correction operations based on FOV information indicated by the size/FOV data 134, other operations, or a combination thereof. As an example, the image signal processor 122 may perform a scaling operation, a cropping operation, or the like, on the image data 132 to generate processed image data 138 that represents a processed image having the same size (or another characteristic with the same or similar value) as the first image. As another example, the image signal processor 122 may perform an FOV correction operation on the image data 132, which may include rotating the second image, cropping a portion of the second image, scaling the second image, or other operations, to substantially match a FOV associated with the scene depicted in the first image with a FOV associated with a scene depicted the processed second image represented by the processed image data 138.

The resizing operations, the FOV correction operations, or both, that are performed by the image signal processor 122 may be based on the size/FOV data 134, which indicates predetermined differences in sizes, scaling, rotation, FOV, or the like, between images associated with the first camera 110 and images associated with the second camera 112 (or two other cameras expected to be used during the reflection removal process). In some examples, the image signal processor 122 may also perform one or more image processing operations on the image data 130, such as to standardize a format or characteristics of the first image with a common format or characteristics used by the NPU 124. Performance of the image processing operations on the image data 130 and the image data 132 by the image signal processor 122 generates processed image data 136 and the processed image data 138, respectively. The above-described operations may be performed prior to identification of any regions that include reflective objects in the first image. After generating the processed image data 136 and the processed image data 138, the image signal processor 122 provides the processed image data 136 and the processed image data 138 to the NPU 124.

The NPU 124 receives the processed image data 136 and the processed image data 138 (or the image data 130, the image data 132, or both, if some or no processing is performed by the image signal processor 122), and the NPU 124 identifies, based on the processed image data 138, a region in the first image that includes one or more reflected artifacts. The reflected artifacts may include reflected objects, reflected faces, or other reflections that are depicted in reflective surface(s) in image(s). To illustrate, the NPU 124 may analyze the processed image data 138 to identify one or more portions of the second image that can be used to identify the region in the first image that includes the reflected artifact(s). The analysis may include segmenting the second image and generating a mask, performing object recognition operation(s) on the first and second images, performing facial recognition operation(s) on the first and second images, other image analysis operations, or a combination thereof.

As an example of the image analysis, the NPU 124 can perform a segmentation operation on the processed image data 138 to segment the second image into a background portion and a foreground portion. In the above-described example in which the first image includes a reflective surface that includes a reflection of the user, the foreground portion of the second image includes the user (e.g., a non-reflected view of the user). Thus, in this example, the NPU 124 generates the segmentation mask 144 based on the foreground portion of the second image (represented by the processed image data 138). The NPU 124 may perform a comparison of the segmentation mask 144 and the first image (represented by the processed image data 136) to identify the region in the first image that includes the reflection of the user. In some embodiments, the NPU 124 may perform one or more resizing operations on the segmentation mask 144 based on size information, indicated by the size/FOV data 134, that is associated with the processed image data 136. Additionally, or alternatively, the NPU 124 may perform one or more FOV correction operations on the segmentation mask 144 based on FOV information, indicated by the size/FOV data 134, that is associated with the first camera 110 and the second camera 112. Additionally, or alternatively, the NPU 124 may perform one or more transformation operations on the segmentation mask 144 based on a focal length of the first camera 110 and a focal length of the second camera 112, both of which may be indicated by the size/FOV data 134. The resizing operations, the FOV correction operations, the transformation operations, or a combination thereof, may be similar those described above with reference to the image signal processor 122 (and in some embodiments, the NPU 124 may pass the segmentation mask 144 to the image signal processor 122 for performance of the operations to harmonize one or more characteristics of the segmentation mask 144 with the first image).

As another example, the NPU 124 may perform object recognition operation(s), facial recognition operation(s), or both, on the processed image data 138 and the processed image data 136. In this example, the NPU 124 may identify the region in the first image that includes the reflected artifacts based on a comparison of recognized objects and/or faces from the second image to recognized objects or faces in the first image. For example, the NPU 124 may identify a region in the first image that includes one or more common objects or common faces that appear in both the first image and the second image. A pair of common objects (or faces) may be identified in the first and second images if a similarity score based on an object (or face) in the first image and an object (or face) in the second image satisfies (e.g., is greater than, or greater than or equal to) a similarity threshold. In other examples, common objects or faces may be identified if a corresponding difference metric is less than, or is less than or equal to, a difference threshold.

The NPU 124 also generates the fill-in image data 140 based on the processed image data 136. The fill-in image data 140 represents a fill-in image that looks similar to what would reasonably appear in the identified region of the first image (e.g., the region that includes the reflected artifact(s)). In some embodiments, the NPU 124 leverages generative AI to perform on-device generation of the fill-in image data 140 that represents a fill-in image that appears similar to portion(s) of the first image. For example, the NPU 124 may include, or may be configured to operate as, a trained AI image generator (e.g., the generative model 142) that generates the fill-in image data 140. According to some aspects of the present disclosure, the NPU 124 may provide a portion of the processed image data 136 (or the image data 130) as input to the generative model 142 to generate the fill-in image data 140. The provided portion of the processed image data 136 may correspond to the identified region in the first image that includes the reflected artifact(s). Additionally, or alternatively, the NPU 124 may provide a different portion of the processed image data 136 that corresponds to a different portion (e.g., a remainder of the first image that does not include the identified region) of the first image as input to the generative model 142 to generate the fill-in image data 140. In some embodiments, the NPU 124 performs one or more post-processing operations on the fill-in image data 140 to further match the fill-in image (or a portion thereof) to the first image, such as resizing the fill-in image, adjusting a brightness or contrast of the fill-in image, cropping the fill-in image, scaling the fill-in image, rotating the fill-in image, blurring the fill-in image, other operations, or a combination thereof.

After generating the fill-in image data 140, the NPU 124 generates the output image data 146 that represents the first image with the identified region replaced by the fill-in image. To illustrate, the NPU 124 may maintain pixel values from the first image in the output image if the pixels correspond to other regions of the first image than the identified region that includes the reflected artifact(s). Additionally, the NPU 124 may include pixel values from the fill-in image in the output image in place of the pixel values that correspond to pixels within the identified region in the first image. Stated differently, the output image represented by the output image data 146 includes a first plurality of pixels corresponding to a remainder of the first image (e.g., that does not include the identified region) and a second plurality of pixels corresponding to the fill-in image (e.g., that replace the pixels in the first image that are located within the identified region). In some embodiments, to blend the fill-in image with the first image in generating the output image, the output image also includes a third plurality of pixels corresponding to the fill-in image. In such embodiments, the third plurality of pixels are included in one or more locations adjacent to the region in the output image to combine the first image and the fill-in image in a more “naturally looking” manner, such as by replacing objects or other visual elements that are partially removed by replacing the identified region, making smoother one or more transitions (e.g., with respect to lighting, color, brightness, etc.) between the fill-in image and the remainder of the first image, or a combination thereof. After generating the output image data 146, the processor 108 may store the output image data 146 at the memory 106, provide the output image data 146 to the display device 116 for display to the user (e.g., during an image preview operation or during playout of video), provide the output image data 146 to the modem 118 for transmission to another device, or a combination thereof.

One technical advantage of implementing the device 102 as described above is that the device 102 performs on-device image processing that eliminates reflected artifacts within an image, that improves user experience, and that preserves user privacy. For example, as compared to other image processing techniques that may blur or adjust lighting of user-selected objects in images, the device 102 (e.g., the NPU 124) accurately identifies reflected objects in the first image represented by the image data 130 (or the processed image data 136) and eliminates the reflected objects by replacing them based on the fill-in image data 140. This can improve the look of the first image by making it more difficult for a viewer to recognize that the first image has been modified, as compared to blurring or adjusting lighting in a region of the first image that includes the reflected objects. The NPU 124 is able to identify the reflected objects in the first image automatically and without user input, such as by using the segmentation mask 144 or performing object or facial recognition operations on the image data 130 and the image data 132 (or the processed image data 136 and/or the processed image data 138, respectively). Additionally, by employing the generative model 142 stored at the device 102, the device 102 performs on-device image processing and modification that does not share the user's private images with other parties, thereby preserving user privacy as compared to sending the images for off-device modification, such as to a cloud-based image modification service.

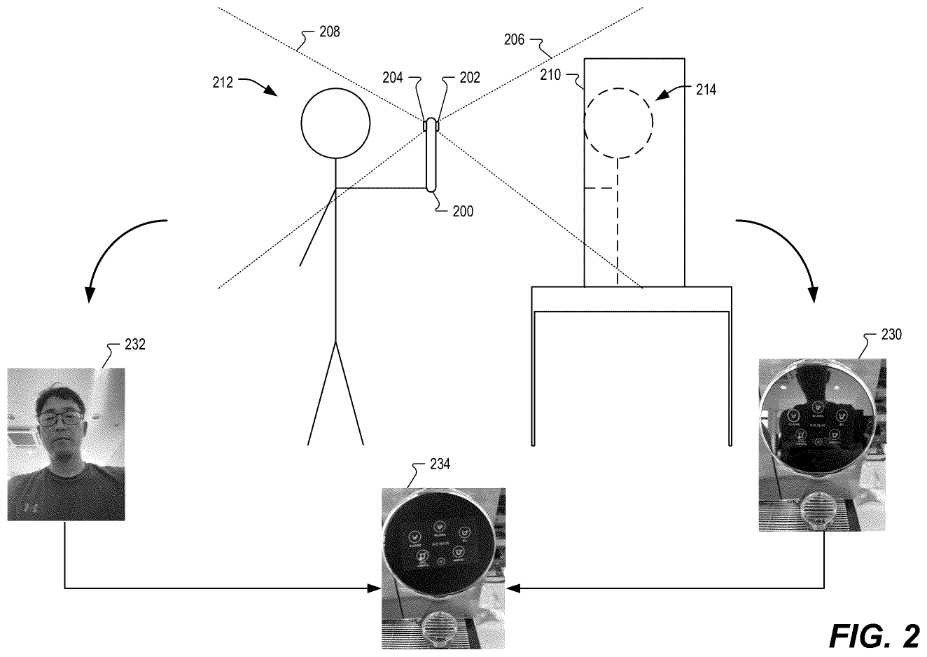

FIG. 2 depicts an example of capturing images using multiple cameras facing in different directions for use in generating an output image without a reflected artifact, in accordance with one or more aspects of the present disclosure. The example illustrated in FIG. 2 is described with reference to a device 200, which is illustrated as a smart phone. In some embodiments, the device 200 may include or correspond to the device 102 of FIG. 1. The device 200 includes a first camera 202 (e.g., a rear-facing camera) and a second camera 204 (e.g., a front-facing camera). The first camera 202 may include one or more cameras that are configured for capturing high-quality images at a variety of distances and in a variety of lighting conditions, and the second camera 204 may include a camera that is configured for capturing lower quality images (e.g., “selfies”) of the user.

In the example shown in FIG. 2, a user captures a first image 230 with the first camera 202 and a second image 232 with the second camera 204. In some examples, the second image 232 may be captured concurrently with, or soon after, capture of the first image 230. In some other examples, the second image 232 may be captured during a later time period with respect to capture of the first image 230, such as based on instructions from a reflection removal application or a photo library application executed at the device 200. In the example shown in FIG. 2, the first image 230 includes a reflected artifact 214 depicted on or in a reflective surface 210 within a visual scene within a first FOV 206 of the first camera 202. It is noted that the reflected artifact 214 is illustrated in FIG. 2 to aid in understanding of one or more aspects described herein, even though the reflected artifact 214 may not be visible from the perspective depicted in FIG. 2. In this example, the second image 232 includes a non-reflected image of a user 212 within a second FOV 208 of the second camera 204. As a particular illustrative example, the reflective surface 210 may be a metal surface of an expresso machine that reflects the face of the user 212 when the first image 230 is captured by the first camera 202. The first image 230 and the second image 232 may be processed during performance of a reflection removal process to generate an output image 234. As can be appreciated, the reflected artifact 214 (e.g., the reflection of the user 212) that is included in the first image 230 is not included in the output image 234.

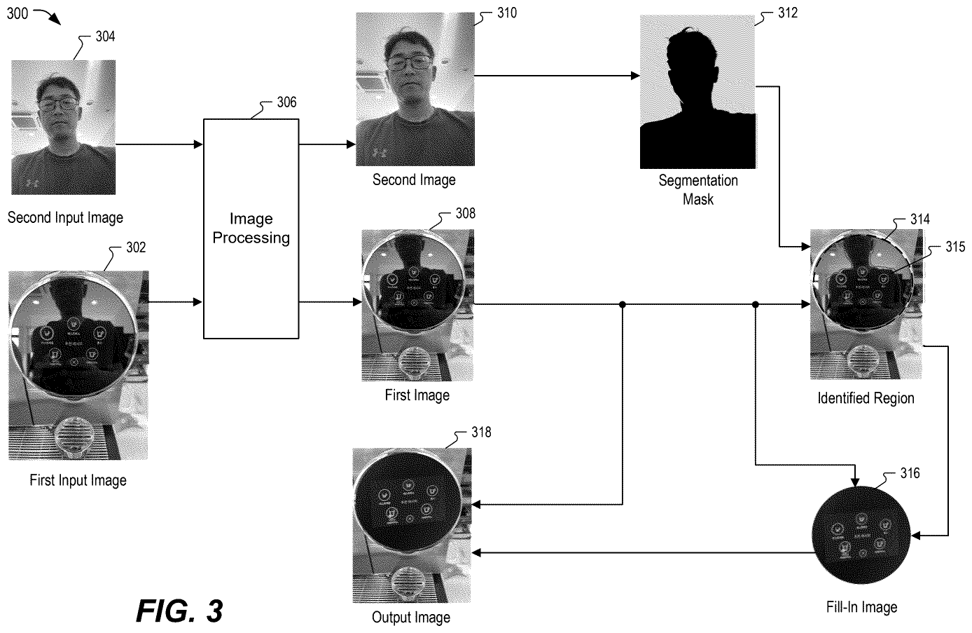

FIG. 3 depicts a diagram of an example of image processing operations 300 performed to eliminate reflected artifacts in an image, in accordance with one or more aspects of the present disclosure. In some examples, the image processing operations 300 may be performed by the system 100 or the device 102 (e.g., the processor 108, the image corrector 120, the image signal processor 122, the NPU 124, or a combination thereof) of FIG. 1 or the device 200 of FIG. 2.

The image processing operations 300 include obtaining first image data that indicates a first input image 302 and second image data that indicates a second input image 304. The first input image 302 and the second input image 304 may include or correspond to the first image 230 and the second image 232 of FIG. 2, respectively. The image processing operations 300 include performing image processing 306 on the corresponding image data for the input images 302, 304 to generate a first image 308 (e.g., a first processed image) and a second image 310 (e.g., a second processed image). In some embodiments, the image processing 306 includes the image processing operations described with reference to the image signal processor 122 of FIG. 1. For example, the image processing 306 may include resizing operation(s), FOV correction operation(s), transformation operation(s), or a combination thereof.

In the example shown in FIG. 3, the image processing operations 300 include generating a segmentation mask 312 based on the second image 310. For example, the second image 310 may be segmented into a foreground pixels (e.g., that represent the user in this example) and background pixels (e.g., that represent a portion of the wall and ceiling in the room with the user in this example). In this example, the foreground pixels may be converted to a first value to form a solid shape having the same outline as the user, and the background pixels may be converted to a second value (e.g., one that has a high contrast with the first value) to generate the segmentation mask 312. The segmentation mask 312 may be utilized to identify a region 314 (e.g., an identified region) within the first image 308 that includes a reflected artifact 315. For example, the region 314 may correspond to a portion of the reflective surface in the first image 308 in which the reflection of the user (e.g., the reflected artifact 315) is located. The reflected artifact 315 may most closely match the shape of the segmentation mask 312 and be identified by comparing the segmentation mask 312 to the first image 308. In the example shown in FIG. 3, the region 314 is larger than, and has a simpler shape (e.g., an ellipsoid) than, the reflected artifact 315, but in other examples, the region 314 can have the same shape, size, or both, as the reflected artifact 315. Additionally, although the region 314 is described as being identified based on the segmentation mask 312, in other embodiments, the region 314 can be identified by performing one or more object recognition operations, one or more facial recognition operations, or both, on the first image 308 and the second image 310 and comparing the results, as described above with reference to FIG. 1.

The image processing operations 300 include generating a fill-in image 316 based on the first image 308, the region 314, or both. The fill-in image 316 appears similar to at least a portion of the first image 308 but does not include any reflected artifacts. In the example shown in FIG. 3, the fill-in image 316 includes icons of the expresso machine's control panel overlaid on a background surface having a different color and visual appearance than the reflective surface of the expresso machine in the region 314. In some embodiments, the fill-in image 316 is generated using a trained AI image generator (e.g., the generative model 142 of FIG. 1), such as by providing the region 314, or an entirety of the first image 308, as input to the trained AI image generator.

The image processing operations 300 also include generating an output image 318 based on the first image 308 and the fill-in image 316. The output image 318 corresponds to the first image 308 in which the region 314 is replaced with the fill-in image 316. For example, the output image 318 may include a first plurality of pixels from the first image 308 (e.g., the pixels of the regions surrounding the reflected artifact 315) and a second plurality of pixels from the fill-in image 316 (e.g., the pixels that correspond to region 314 in the first image 308). As can be seen in FIG. 3, the output image 318 does not include the reflected artifact 315 (e.g., the reflection of the user) that is included in the first image 308. Thus, the image processing operations 300 may be performed as part of an on-device process to remove (e.g., eliminate) reflections from an image.

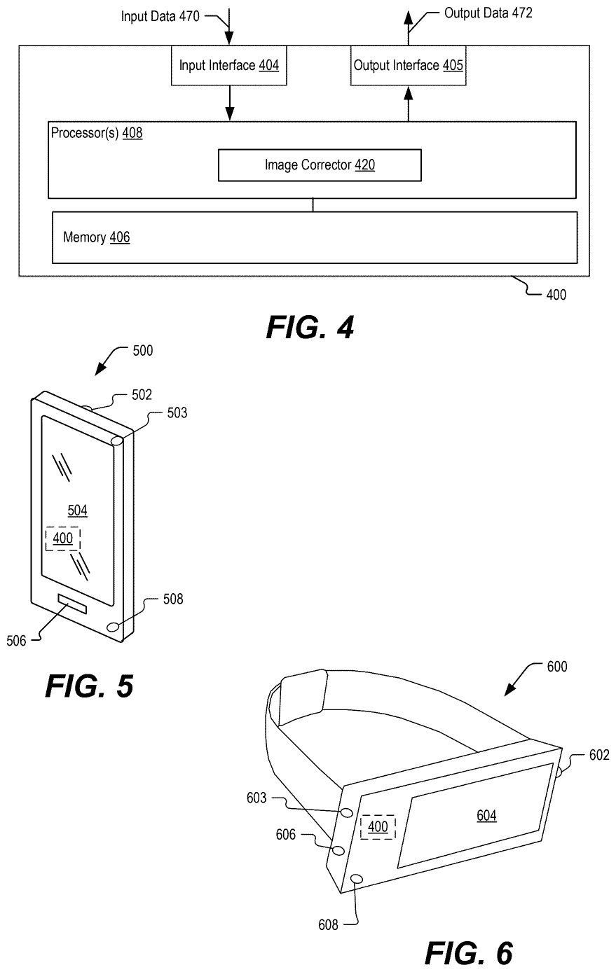

FIG. 4 depicts a diagram of an example of an integrated circuit 400 operable to eliminate reflected artifacts in an image, in accordance with some examples of the present disclosure. The integrated circuit 400 includes one or more processors 408 (herein after referred to as the “processor 408”) and a memory 406. The processor 408 and the memory 406 may include or correspond to the processor 108 and the memory 106, respectively. The processor 408 may include an image corrector 420. The image corrector 420 may include or correspond to image corrector 120 of FIG. 1.

The integrated circuit 400 also includes an input interface 404, such as one or more bus interfaces, to enable the integrated circuit 400 to receive signals representing input data 470 for processing. For example, the input data 470 can correspond to or include the input image data 111, the input image data 113, the input data 115, the image data 130, the image data 132, the size/FOV data 134, or a combination thereof.

The integrated circuit 400 also includes an output interface 405, such as a bus interface, to enable the integrated circuit 400 to output signals representing output data 472. For example, the output data 472 can correspond to or include the output image data 146, the processed image data 136, the processed image data 138, the fill-in image data 140, the segmentation mask 144, or a combination thereof.

The integrated circuit 400 including the image corrector 420 enables implementation of reflected artifact removal from an image as a component in a system or a device. For example, the system or the device may include a mobile device (e.g., a mobile phone or tablet) as depicted in FIG. 5, a wearable electronic device as depicted in FIG. 6, a camera as depicted in FIG. 7, or a vehicle as depicted in FIG. 8 or FIG. 9.

In some embodiments, the system or the device that includes the integrated circuit 400 also includes or is coupled to one or more cameras, an input device (e.g., a microphone, a keyboard or touch screen, etc.), a display device, a speaker, a modem, or a combination thereof. For example, the one or more cameras, the input device, the display device, the speaker, and the modem may include or correspond to the first camera 110 and the second camera 112, the input device 114, the display device 116, the speaker 117, and the modem 118, respectively.

In some embodiments, the system or the device that includes the integrated circuit 400 and the image corrector 420 is operable to obtain image data representing multiple images captured by differently-facing cameras of the system or the device. The system or device that includes the integrated circuit 400 is also operable to identify a region in a first image that includes one or more reflected objects and to generate fill-in image data that represents a fill-in image. Identifying the region that includes the reflected objects and generating the fill-in image data enables the system or the device to generate an output image that corresponds to the first image in which the region is replaced with the fill-in image, thereby performing on-device elimination of reflected artifact(s) in an image, which can improve a user experience of the system or device that includes the integrated circuit 400 while avoiding privacy issues associated with sending user images to other devices.

FIG. 5 depicts a diagram of a mobile device 500 operable to eliminate reflected artifacts in an image, in accordance with some examples of the present disclosure. The mobile device 500 may include or correspond to a phone or a tablet, as illustrative, non-limiting examples. The mobile device 500 includes a first camera 502 (e.g., an image sensor), a second camera 503, a display 504 (e.g., a display screen), a microphone 506, a speaker 508, and the integrated circuit 400. The first camera 502 (e.g., a rear-facing camera) faces a first direction and the second camera 503 (e.g., a front-facing camera) faces a second direction that is opposite to the first direction. Components of the integrated circuit 400, including the image corrector 420, are integrated in the mobile device 500 and are illustrated using dashed lines to indicate internal components that are not generally visible to a user of the mobile device 500.

In a particular example, the image corrector 420 is operable to obtain first image data representing a first image captured by the first camera 502 and second image data representing a second image captured by the second camera 503. In this example, the image corrector 420 is also operable to identify, based on the second image data, a region in the first image that includes one or more reflected objects and to generate fill-in image data, based on the first image data, that represents a fill-in image. Identifying the region that includes the reflected objects and generating the fill-in image data enables the mobile device 500 to generate an output image that corresponds to the first image in which the region is replaced with the fill-in image, thereby performing on-device elimination of reflected artifact(s) in an image, such as a reflection of a user of the mobile device 500. Accordingly, the image corrector 420 enables the mobile device 500 to improve a user experience associated with image display at the mobile device 500 while avoiding privacy issues associated with sending user images to other devices.

FIG. 6 depicts a diagram of a wearable electronic device 600 operable to eliminate reflected artifacts in an image, in accordance with some examples of the present disclosure. The wearable electronic device 600 may include or correspond to a “smart watch,” as an illustrative, non-limiting example. The wearable electronic device 600 includes a first camera 602 (e.g., an image sensor), a second camera 603, a display 604 (e.g., a display screen), a microphone 606, a speaker 608, and the integrated circuit 400. The first camera 602 faces a first direction and the second camera 603 faces a second direction that is opposite to the first direction. Components of the integrated circuit 400, including image corrector 420, are integrated in the wearable electronic device 600 and are illustrated using dashed lines to indicate internal components that are not generally visible to a user of the wearable electronic device 600.

In a particular example, the image corrector 420 is operable to obtain first image data representing a first image captured by the first camera 602 and second image data representing a second image captured by the second camera 603. In this example, the image corrector 420 is also operable to identify, based on the second image data, a region in the first image that includes one or more reflected objects and to generate fill-in image data, based on the first image data, that represents a fill-in image. Identifying the region that includes the reflected objects and generating the fill-in image data enables the wearable electronic device 600 to generate an output image that corresponds to the first image in which the region is replaced with the fill-in image, thereby performing on-device elimination of reflected artifact(s) in an image, such as a reflection of a user of the wearable electronic device 600. Accordingly, the image corrector 420 enables the wearable electronic device 600 to improve a user experience associated with image display at the wearable electronic device 600 while avoiding privacy issues associated with sending user images to other devices.

FIG. 7 is a diagram of a camera device 700 operable to eliminate reflected artifacts in an image, in accordance with some examples of the present disclosure. The camera device 700 includes a first image sensor 702, a second image sensor 703, a display 704 (e.g., a display screen), a microphone 706, a speaker 708, and the integrated circuit 400. The first image sensor 702 (e.g., a front-facing camera) faces a first direction and the second image sensor 703 (e.g., a rear-facing camera) faces a second direction that is opposite to the first direction. Components of the integrated circuit 400, including the image corrector 420 are integrated in the camera device 700 and are illustrated using dashed lines to indicate internal components that are not generally visible to a user of the camera device 700.

In a particular example, the image corrector 420 is operable to obtain first image data representing a first image captured by the first image sensor 702 and second image data representing a second image captured by the second image sensor 703. In this example, the image corrector 420 is also operable to identify, based on the second image data, a region in the first image that includes one or more reflected objects and to generate fill-in image data, based on the first image data, that represents a fill-in image. Identifying the region that includes the reflected objects and generating the fill-in image data enables the camera device 700 to generate an output image that corresponds to the first image in which the region is replaced with the fill-in image, thereby performing on-device elimination of reflected artifact(s) in an image, such as a reflection of a user of the camera device 700. Accordingly, the image corrector 420 enables the camera device 700 to improve a user experience associated with image display at the camera device 700 while avoiding privacy issues associated with sending user images to other devices.

FIG. 8 is a diagram of a first example of a vehicle 800 operable to eliminate reflected artifacts in an image, in accordance with some examples of the present disclosure. The vehicle 800 may include or correspond to a manned or unmanned aerial device (e.g., a package delivery drone). The vehicle 800 includes a first camera 802 (e.g., an image sensor), a second camera 803, a display 804 (e.g., a display screen), a microphone 806, a speaker 808, and the integrated circuit 400. The first camera 802 (e.g., a front-facing camera) faces a first direction and the second camera 803 (e.g., a rear-facing camera) faces a second direction that is opposite to the first direction. Components of the integrated circuit 400, including the image corrector 420, are integrated in the vehicle 800 and are illustrated using dashed lines to indicate internal components that are not generally visible to a user of the vehicle 800.

In a particular example, the image corrector 420 is operable to obtain first image data representing a first image captured by the first camera 802 and second image data representing a second image captured by the second camera 803. In this example, the image corrector 420 is also operable to identify, based on the second image data, a region in the first image that includes one or more reflected objects and to generate fill-in image data, based on the first image data, that represents a fill-in image. Identifying the region that includes the reflected objects and generating the fill-in image data enables the vehicle 800 to generate an output image that corresponds to the first image in which the region is replaced with the fill-in image, thereby performing on-device elimination of reflected artifact(s) in an image, such as a reflection of an object or person that is behind the vehicle 800. Accordingly, the image corrector 420 enables the vehicle 800 to eliminate reflected objects in images captured by the vehicle 800 while avoiding privacy issues associated with sending the captured images to other devices.

FIG. 9 is a diagram of a second example of a vehicle 900 operable to eliminate reflected artifacts in an image, in accordance with some examples of the present disclosure. The vehicle 900 may include or correspond to a car. The vehicle 900 includes a camera 902 (e.g., an image sensor) within an interior of the vehicle 900, a display 904 (e.g., a display screen), a microphone 906, one or more speakers 908, and the integrated circuit 400. The vehicle 900 also includes a first external camera 910 (e.g., a front-facing camera) and a second external camera (e.g., a rear-facing camera such as a back-up camera, not shown in FIG. 9). The first external camera 910 faces a first direction and the second camera faces a second direction that is opposite to the first direction. Components of the integrated circuit 400, including the image corrector 420, are integrated in the vehicle 900 and are illustrated using dashed lines to indicate internal components that are not generally visible to a user of the vehicle 900.

In a particular example, the image corrector 420 is operable to obtain first image data representing a first image captured by the first external camera 910 and second image data representing a second image captured by the second camera. In this example, the image corrector 420 is also operable to identify, based on the second image data, a region in the first image that includes one or more reflected objects and to generate fill-in image data, based on the first image data, that represents a fill-in image. Identifying the region that includes the reflected objects and generating the fill-in image data enables the vehicle 900 to generate an output image that corresponds to the first image in which the region is replaced with the fill-in image, thereby performing on-device elimination of reflected artifact(s) in an image, such as a reflection of an object or person that is behind the vehicle 900. Accordingly, the image corrector 420 enables the vehicle 900 to eliminate reflected objects or people in images captured by the vehicle 900 while avoiding privacy issues associated with sending the captured images to other devices.

The embodiments of the systems or devices as described with reference to FIGS. 4-9 are described, respectively, as including a display, a microphone, a speaker, cameras, or a combination thereof. As described with reference to FIGS. 4-9, the display, the microphone, the speaker, the first camera, and the second camera may include or correspond to the display device 116, the input device 114, the speaker 117, the first camera 110, and the second camera 112, respectively. It is noted that in other embodiments of the systems or devices of FIGS. 4-9, one or more of the systems or devices of FIGS. 4-9 may not include the display, the microphone, the speaker, the cameras, or a combination thereof. Additionally, or alternatively, one or more of the systems or devices of FIGS. 4-9 may include an additional component. For example, the additional component may include a modem, such as the modem 118.

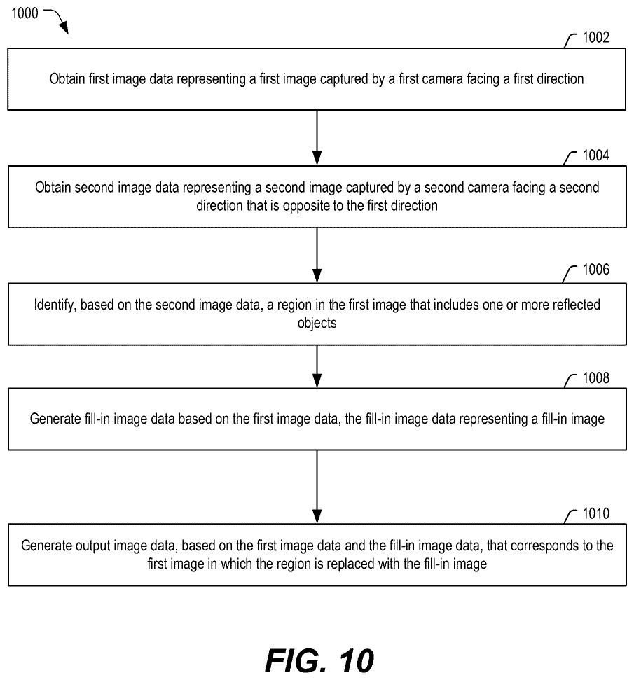

FIG. 10 is a diagram of an example of a method 1000 of eliminating reflected artifacts in an image, in accordance with some aspects of the present disclosure. In a particular aspect, one or more operations of the method 1000 are performed by the system 100, the device 102, the processor 108, the image corrector 120, the image signal processor 122, the NPU 124, the device 200, the image corrector 420, the integrated circuit 400, the image corrector 420, the mobile device 500, the wearable electronic device 600, the camera device 700, the vehicle 800, the vehicle 900, or a combination thereof.

In some embodiments, the method 1000 includes, at block 1002, obtaining first image data representing a first image captured by a first camera facing a first direction. For example, the image corrector 120 obtains the image data 130 that represents a first image captured by a first camera facing a first direction. In this example, the image data 130 may include or correspond to the input image data 111 that represents an image captured by the first camera 110.

The method 1000 also includes, at block 1004, obtaining second image data representing a second image captured by a second camera facing a second direction that is opposite to the first direction. For example, the image corrector 120 obtains the image data 132 that represents a second image captured by a second camera facing a second direction. In this example, the image data 132 may include or correspond to the input image data 113 that represents an image captured by the second camera 112 in a direction that is opposite to the direction of the first camera 110.

The method 1000 further includes, at block 1006, identifying, based on the second image data, a region in the first image that includes one or more reflected objects. For example, the NPU 124 identifies a region in the image data 130 (or optionally the processed image data 136) that includes reflected object(s) based on the image data 132 (or the processed image data 138). The region may include or correspond to the region 314 that includes the reflected artifact 315 of FIG. 3.

The method 1000 includes, at block 1008, generating fill-in image data based on the first image data. For example, the NPU 124 generates the fill-in image data 140 based on the image data 130 (or the processed image data 136). The fill-in image data represents a fill-in image.

The method 1000 includes, at block 1010, generating output image data, based on the first image data and the fill-in image data, that corresponds to the first image in which the region is replaced with the fill-in image. For example, the NPU 124 generates the output image data 146 based on the image data 130 (or the processed image data 136) and the fill-in image data 140. In some examples, the output image data represents an output image that includes a first plurality of pixels corresponding to a remainder of the first image that does not include the region and a second plurality of pixels corresponding to the fill-in image that are included within the region of the output image. For example, the output image data may represent the output image 318 that includes pixels of the fill-in image 316 in place of the region 314 in addition to a remainder of the pixels of the first image 308. In some such examples, the output image includes a third plurality of pixels corresponding to the fill-in image that are included in one or more locations adjacent to the region in the output image.

In some embodiments, the method 1000 includes, prior to identification of the region in the first image, performing one or more resizing operations on the second image data based on size information associated with the first image data. For example, the image signal processor 122 may perform one or more resizing operations on the image data 132 based on the size/FOV data 134. Additionally, or alternatively, the method 1000 may include, prior to identification of the region in the first image, performing one or more FOV correction operations on the second image data based on FOV information associated with the first camera and the second camera. For example, the image signal processor 122 may perform one or more FOV correction operations on the image data 132 based on the size/FOV data 134.

In some embodiments, the method 1000 includes generating a segmentation mask based on the second image and performing a comparison of the segmentation mask and the first image. The region in the first image is identified based on the segmentation mask. For example, the NPU 124 may generate the segmentation mask 144 based on the processed image data 138 and compare the segmentation mask 144 to the processed image data 136 to identify the region, as further described with reference to FIG. 3. In some such embodiments, the method 1000 also includes performing one or more resizing operations on the segmentation mask based on size information associated with the first image data, performing one or more FOV correction operations on the segmentation mask based on FOV information associated with the first camera and the second camera, performing one or more transformation operations on the segmentation mask based on a focal length of the first camera, or a combination thereof. For example, the NPU 124 (and/or the image signal processor 122) may perform resizing operation(s), FOV correction operation(s), transformation operation(s), or a combination thereof, on the segmentation mask 144 based on the size/FOV data 134.

In some embodiments, the method 1000 includes performing one or more object recognition operations based on the first image data and the second image data and identifying a common object that is included in the first image and the second image based on the one or more object recognition operations. The one or more reflected objects include the common object. For example, the NPU 124 may perform object recognition operation(s) based on the processed image data 136 and the processed image data 138 to identify one or more common objects that are recognized in both the first image and the second image. Additionally, or alternatively, the method 1000 may include performing one or more facial recognition operations based on the first image data and the second image data and identifying a common face that is included in the first image and the second image based on the one or more facial recognition operations. The one or more reflected objects include the common face. For example, the NPU 124 may perform facial recognition operation(s) based on the processed image data 136 and the processed image data 138 to identify one or more common faces that are recognized in both the first image and the second image.

In some embodiments, the method 1000 includes performing on-device generation of the fill-in image data utilizing a trained artificial intelligence image generator. For example, the trained artificial intelligence image generator may include or correspond to the generative model 142. In some such embodiments, the method 1000 also includes providing a portion of the first image data as input to the trained artificial intelligence image generator to generate the fill-in image data. The portion of the first image data corresponds to the region in the first image. For example, the region 314 may be provided as input to a trained AI image generator (e.g., the generative model 142) to generate the fill-in image 316. Additionally, or alternatively, the method 1000 may include providing a portion of the first image data as input to the trained artificial intelligence image generator to generate the fill-in image data. The portion of the first image data corresponds to a remainder of the first image that does not include the region. For example, the first image 308, or the first image 308 without the region 314, may be provided as input to a trained AI image generator (e.g., the generative model 142) to generate the fill-in image 316.

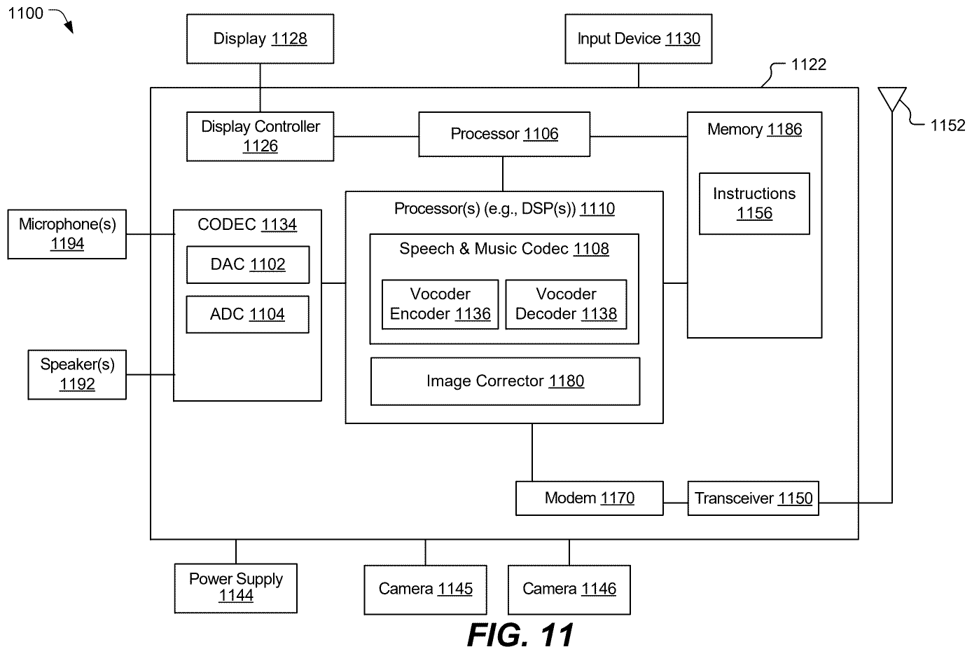

The method 1000 of FIG. 10 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1000 of FIG. 10 may be performed by a processor that executes instructions, such as described with reference to FIG. 11.

It is noted that one or more blocks (or operations) described with reference to FIG. 10 may be combined with one or more blocks (or operations) described with reference to another of the figures. For example, one or more blocks associated with FIG. 10 may be combined with one or more blocks (or operations) associated with FIGS. 1-9. Additionally, or alternatively, one or more operations described above with reference to FIGS. 1-10 may be combined with one or more operations described with reference to FIG. 11.

FIG. 11 is a block diagram of an illustrative example of a device 1100 that is operable to eliminate reflected artifacts in an image, in accordance with one or more aspects of the present disclosure. In various embodiments, the device 1100 may have more or fewer components than illustrated in FIG. 11. In an illustrative embodiment, the device 1100 may correspond to the device 102. In an illustrative embodiment, the device 1100 may perform one or more operations described with reference to FIGS. 1-10.

In a particular embodiment, the device 1100 includes a processor 1106 (e.g., a CPU). The device 1100 may include one or more additional processors 1110 (e.g., one or more digital signal processors (DSPs)). In a particular aspect, the processor 108 of FIG. 1 or the processor 408 of FIG. 4 corresponds to the processor 1106, the processor(s) 1110, or a combination thereof. The processor(s) 1110 may include a speech and music coder-decoder (CODEC) 1108 that includes a voice coder (“vocoder”) encoder 1136, a vocoder decoder 1138, or a combination thereof. Additionally, or alternatively, the processor(s) 1110 may include an image corrector 1180. The image corrector 1180 may include or correspond to the image corrector 120 of FIG. 1 or the image corrector 420 of FIG. 4.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, CPUs, DSPs, neural processing units (NPUs), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1100 may include a memory 1186 and a CODEC 1134. The memory 1186 may include or correspond to the memory 106 of FIG. 1 or the memory 406 of FIG. 4. The memory 1186 may include instructions 1156, that are executable by the processor(s) 1110 (or the processor 1106) to implement the functionality described with reference to the image corrector 1180. The instructions 1156 may include or correspond to the instructions 109 of FIG. 1. The device 1100 may include a modem 1170 coupled, via a transceiver 1150, to an antenna 1152. The modem 1170 may include or correspond to the modem 118 of FIG. 1.

The device 1100 may include a display 1128 coupled to a display controller 1126. The display 1128 may include or correspond to the display device 116 of FIG. 1. One or more speakers 1192, one or more microphones 1194, or both, may be coupled to the CODEC 1134. The speaker(s) 1192 may include or correspond to the speaker 117 of FIG. 1. The CODEC 1134 may include a digital-to-analog converter (DAC) 1102, an analog-to-digital converter (ADC) 1104, or both. In a particular embodiment, the CODEC 1134 may receive analog signals from the microphone(s) 1194, convert the analog signals to digital signals using the ADC 1104, and provide the digital signals to the speech and music codec 1108. The speech and music codec 1108 may process the digital signals. In a particular embodiment, the speech and music codec 1108 may provide digital signals to the CODEC 1134. The CODEC 1134 may convert the digital signals to analog signals using the DAC 1102 and may provide the analog signals to the speaker(s) 1192.

In a particular embodiment, the device 1100 may be included in a system-in-package or system-on-chip device 1122. In a particular embodiment, the memory 1186, the processor 1106, the processor(s) 1110, the display controller 1126, the CODEC 1134, and the modem 1170 are included in the system-in-package or system-on-chip device 1122. In a particular embodiment, an input device 1130, a power supply 1144, a camera 1145, and a camera 1146 are coupled to the system-in-package or the system-on-chip device 1122. For example, the input device 1130, the camera 1145, and the camera 1146 may include or correspond to the input device 114, the first camera 110, and the second camera 112, respectively. The camera 1145 (e.g., a front-facing camera) faces a first direction and the camera 1146 (e.g., a rear-facing camera) faces a second direction that is opposite to the first direction. In some examples, the input device 1130 may include or be associated with the display device 116 or the display 1128. Moreover, in a particular embodiment, as illustrated in FIG. 11, the display 1128, the input device 1130, the speaker(s) 1192, the microphone(s) 1194, the antenna 1152, the power supply 1144, the camera 1145, and the camera 1146 are external to the system-in-package or the system-on-chip device 1122. In a particular embodiment, each of the display 1128, the input device 1130, the speaker(s) 1192, the microphone(s) 1194, the antenna 1152, the power supply 1144, the camera 1145, and the camera 1146 may be coupled to a component of the system-in-package or the system-on-chip device 1122, such as an interface or a controller.

The device 1100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described embodiments and examples, an apparatus includes means for obtaining first image data representing a first image captured in a first direction. For example, the means for obtaining the first image data can include the first camera 110, the image corrector 120, the image signal processor 122, the NPU 124, the processor 108, the device 102, the system 100, the first camera 202, the device 200, the integrated circuit 400, the image corrector 420, the mobile device 500, the wearable electronic device 600, the camera device 700, the vehicle 800, the vehicle 900, the camera 1145, the image corrector 1180, the processor 1106, the processor(s) 1110, the system-in-package or the system-on-chip device 1122, the device 1100, other circuitry configured to obtain first image data representing a first image captured in a first direction, or a combination thereof.

The apparatus also includes means for obtaining second image data representing a second image captured in a second direction that is opposite to the first direction. For example, the means for obtaining the second image data can include the second camera 112, the image corrector 120, the image signal processor 122, the NPU 124, the processor 108, the device 102, the system 100, the second camera 204, the device 200, the integrated circuit 400, the image corrector 420, the mobile device 500, the wearable electronic device 600, the camera device 700, the vehicle 800, the vehicle 900, the camera 1146, the image corrector 1180, the processor 1106, the processor(s) 1110, the system-in-package or the system-on-chip device 1122, the device 1100, other circuitry configured to obtain second image data representing a second image captured in a second direction that is opposite to the first direction, or a combination thereof.

The apparatus also includes means for identifying, based on the second image data, a region in the first image that includes one or more reflected objects. For example, the means for identifying can include the image corrector 120, the NPU 124, the processor 108, the device 102, the system 100, the device 200, the image corrector 420, the integrated circuit 400, the mobile device 500, the wearable electronic device 600, the camera device 700, the vehicle 800, the vehicle 900, the image corrector 1180, the processor 1106, the processor(s) 1110, the system-in-package or the system-on-chip device 1122, the device 1100, other circuitry configured to identify, based on the second image data, a region in the first image that includes one or more reflected objects, or a combination thereof.

The apparatus also includes means for generating fill-in image data based on the first image data. The fill-in image data represents a fill-in image. For example, the means for generating the fill-in image data can include the image corrector 120, the NPU 124, the processor 108, the device 102, the system 100, the device 200, the image corrector 420, the integrated circuit 400, the mobile device 500, the wearable electronic device 600, the camera device 700, the vehicle 800, the vehicle 900, the image corrector 1180, the processor 1106, the processor(s) 1110, the system-in-package or the system-on-chip device 1122, the device 1100, other circuitry configured to generate fill-in image data based on the first image data, or a combination thereof.

The apparatus also includes means for means for generating output image data, based on the first image data and the fill-in image data, that corresponds to the first image in which the region is replaced with the fill-in image. For example, the means for generating the output image data can include the image corrector 120, the NPU 124, the processor 108, the device 102, the system 100, the device 200, the image corrector 420, the integrated circuit 400, the mobile device 500, the wearable electronic device 600, the camera device 700, the vehicle 800, the vehicle 900, the image corrector 1180, the processor 1106, the processor(s) 1110, the system-in-package or the system-on-chip device 1122, the device 1100, other circuitry configured to generate output image data, based on the first image data and the fill-in image data, that corresponds to the first image in which the region is replaced with the fill-in image, or a combination thereof.

In some embodiments, a non-transitory computer-readable medium (e.g., a computer-readable storage device, such as the memory 106 or the memory 1186) includes instructions (e.g., the instructions 109 or the instructions 1156) that, when executed by one or more processors (e.g., the processor 108, the processor(s) 1110, or the processor 1106), cause the one or more processors to obtain first image data (e.g., the input image data 111, the image data 130) representing a first image (the first image 230 or the first image 308) captured by a first camera (e.g., the first camera 110, the first camera 202, or the camera 1145) facing a first direction. The instructions also cause the one or more processors to obtain second image data (e.g., the input image data 113 or the image data 132) representing a second image (e.g., the second image 232 or the second image 310) captured by a second camera (e.g., the second camera 112, the second camera 204, or the camera 1146) facing a second direction that is opposite to the first direction. The instructions cause the one or more processors to identify, based on the second image data, a region (e.g., the region 314) in the first image that includes one or more reflected objects (e.g., the reflected artifact 315). The instructions also cause the one or more processors to generate fill-in image data (e.g., the fill-in image data 140) based on the first image data. The fill-in image data represents a fill-in image (e.g., the fill-in image 316). The instructions cause the one or more processors to generate output image data (e.g., the output image data 146), based on the first image data and the fill-in image data, that corresponds to the first image in which the region is replaced with the fill-in image (e.g., as shown in the output image 234 or the output image 318).

Particular aspects of the disclosure are described below in sets of interrelated Examples:

According to Example 1, a device includes: a memory configured to store first image data representing a first image captured by a first camera facing a first direction; and one or more processors, coupled to the memory. The one or more processors are configured to: obtain second image data representing a second image captured by a second camera facing a second direction that is opposite to the first direction; identify, based on the second image data, a region in the first image that includes one or more reflected objects; generate fill-in image data based on the first image data, the fill-in image data representing a fill-in image; and generate output image data, based on the first image data and the fill-in image data, that corresponds to the first image in which the region is replaced with the fill-in image.

Example 2 includes the device of Example 1, wherein the one or more processors are configured to, prior to identification of the region in the first image, perform one or more resizing operations on the second image data based on size information associated with the first image data.

Example 3 includes the device of Example 1 or Example 2, wherein the one or more processors are configured to, prior to identification of the region in the first image, perform one or more field of view (FOV) correction operations on the second image data based on FOV information associated with the first camera and the second camera.

Example 4 includes the device of any of Examples 1 to 3, wherein the one or more processors are configured to: generate a segmentation mask based on the second image; and perform a comparison of the segmentation mask and the first image, wherein the region in the first image is identified based on the segmentation mask.

Example 5 includes the device of Example 4, wherein the one or more processors are configured to: perform one or more resizing operations on the segmentation mask based on size information associated with the first image data; perform one or more field of view (FOV) correction operations on the segmentation mask based on FOV information associated with the first camera and the second camera; perform one or more transformation operations on the segmentation mask based on a focal length of the first camera; or a combination thereof.

Example 6 includes the device of any of Examples 1 to 5, wherein the one or more processors are configured to: perform one or more object recognition operations based on the first image data and the second image data; and identify a common object that is included in the first image and the second image based on the one or more object recognition operations, wherein the one or more reflected objects include the common object.

Example 7 includes the device of any of Examples 1 to 6, wherein the one or more processors are configured to: perform one or more facial recognition operations based on the first image data and the second image data; and identify a common face that is included in the first image and the second image based on the one or more facial recognition operations, wherein the one or more reflected objects include the common face.

Example 8 includes the device of any of Examples 1 to 7, wherein the one or more processors are configured to perform on-device generation of the fill-in image data utilizing a trained artificial intelligence image generator.

Example 9 includes the device of Example 8, wherein the one or more processors are configured to provide a portion of the first image data as input to the trained artificial intelligence image generator to generate the fill-in image data, wherein the portion of the first image data corresponds to the region in the first image.

Example 10 includes the device of Example 8, wherein the one or more processors are configured to provide a portion of the first image data as input to the trained artificial intelligence image generator to generate the fill-in image data, wherein the portion of the first image data corresponds to a remainder of the first image that does not include the region.

Example 11 includes the device of any of Examples 1 to 10, wherein the output image data represents an output image that includes a first plurality of pixels corresponding to a remainder of the first image that does not include the region and a second plurality of pixels corresponding to the fill-in image that are included within the region of the output image.

Example 12 includes the device of Example 11, wherein the output image includes a third plurality of pixels corresponding to the fill-in image that are included in one or more locations adjacent to the region in the output image.

Example 13 includes the device of any of Examples 1 to 12, and further includes the first camera coupled to the one or more processors and configured to generate the first image data, wherein the first camera is integrated in a back side of the device.

Example 14 includes the device of Example 13, and further includes the second camera coupled to the one or more processors and configured to generate the second image data, wherein the second camera is integrated in a front side of the device.

Example 15 includes the device of any of Examples 1 to 14, and further includes a display coupled to the one or more processors and configured to display an output image based on the output image data.

Example 16 includes the device of any of Examples 1 to 15, and further includes a modem coupled to the one or more processors and configured to receive the first image data, the second image data, or a combination thereof.

Example 17 includes the device of any of Examples 1 to 16, wherein the one or more processors are integrated in at least one of a mobile phone, a tablet computer device, a wearable electronic device, or a camera device, and wherein the mobile phone, the tablet computer device, the wearable electronic device, or the camera device is configured to initiate display of an output image based on the output image data.

Example 18 includes the device of any of Examples 1 to 16, wherein the one or more processors are integrated in a vehicle that is configured to initiate display of an output image based on the output image data.

According to Example 19, a method includes: obtaining, by a device, first image data representing a first image captured by a first camera facing a first direction; obtaining, by the device, second image data representing a second image captured by a second camera facing a second direction that is opposite to the first direction; identifying, by the device and based on the second image data, a region in the first image that includes one or more reflected objects; generating, by the device, fill-in image data based on the first image data, the fill-in image data representing a fill-in image; and generating, by the device, output image data, based on the first image data and the fill-in image data, that corresponds to the first image in which the region is replaced with the fill-in image.

Example 20 includes the method of Example 19, and further includes, prior to identification of the region in the first image, performing one or more resizing operations on the second image data based on size information associated with the first image data.

Example 21 includes the method of Example 19 or Example 20, and further includes, prior to identification of the region in the first image, performing one or more field of view (FOV) correction operations on the second image data based on FOV information associated with the first camera and the second camera.

Example 22 includes the method of any of Examples 19 to 21, and further includes: generating a segmentation mask based on the second image; and performing a comparison of the segmentation mask and the first image, wherein the region in the first image is identified based on the segmentation mask.

Example 23 includes the method of Example 22, and further includes: performing one or more resizing operations on the segmentation mask based on size information associated with the first image data; performing one or more field of view (FOV) correction operations on the segmentation mask based on FOV information associated with the first camera and the second camera; performing one or more transformation operations on the segmentation mask based on a focal length of the first camera; or a combination thereof.

Example 24 includes the method of any of Examples 19 to 23, and further includes: performing one or more object recognition operations based on the first image data and the second image data; and identifying a common object that is included in the first image and the second image based on the one or more object recognition operations, wherein the one or more reflected objects include the common object.

Example 25 includes the method of any of Examples 19 to 24, and further includes: performing one or more facial recognition operations based on the first image data and the second image data; and identifying a common face that is included in the first image and the second image based on the one or more facial recognition operations, wherein the one or more reflected objects include the common face.

Example 26 includes the method of any of Examples 19 to 25, and further includes performing on-device generation of the fill-in image data utilizing a trained artificial intelligence image generator.

Example 27 includes the method of Example 26, and further includes providing a portion of the first image data as input to the trained artificial intelligence image generator to generate the fill-in image data, wherein the portion of the first image data corresponds to the region in the first image.

Example 28 includes the method of Example 26, and further includes providing a portion of the first image data as input to the trained artificial intelligence image generator to generate the fill-in image data, wherein the portion of the first image data corresponds to a remainder of the first image that does not include the region.

Example 29 includes the method of any of Examples 19 to 28, wherein the output image data represents an output image that includes a first plurality of pixels corresponding to a remainder of the first image that does not include the region and a second plurality of pixels corresponding to the fill-in image that are included within the region of the output image.

Example 30 includes the method of Example 29, wherein the output image includes a third plurality of pixels corresponding to the fill-in image that are included in one or more locations adjacent to the region in the output image.

According to Example 31, a non-transitory computer-readable medium stores instructions that, when executed by one or more processors, cause the one or more processors to: obtain first image data representing a first image captured by a first camera facing a first direction; obtain second image data representing a second image captured by a second camera facing a second direction that is opposite to the first direction; identify, based on the second image data, a region in the first image that includes one or more reflected objects; generate fill-in image data based on the first image data, the fill-in image data representing a fill-in image; and generate output image data, based on the first image data and the fill-in image data, that corresponds to the first image in which the region is replaced with the fill-in image.

Example 32 includes the non-transitory computer-readable medium of Example 31, wherein the instructions, when executed by the one or more processors, cause the one or more processors to, prior to identification of the region in the first image, perform one or more resizing operations on the second image data based on size information associated with the first image data.

Example 33 includes the non-transitory computer-readable medium of Example 31 or Example 32, wherein the instructions, when executed by the one or more processors, cause the one or more processors to, prior to identification of the region in the first image, perform one or more field of view (FOV) correction operations on the second image data based on FOV information associated with the first camera and the second camera.

Example 34 includes the non-transitory computer-readable medium of any of Examples 31 to 33, wherein the instructions, when executed by the one or more processors, cause the one or more processors to: generate a segmentation mask based on the second image; and perform a comparison of the segmentation mask and the first image, wherein the region in the first image is identified based on the segmentation mask.

Example 35 includes the non-transitory computer-readable medium of Example 34, wherein the instructions, when executed by the one or more processors, cause the one or more processors to: perform one or more resizing operations on the segmentation mask based on size information associated with the first image data; perform one or more field of view (FOV) correction operations on the segmentation mask based on FOV information associated with the first camera and the second camera; perform one or more transformation operations on the segmentation mask based on a focal length of the first camera; or a combination thereof.

Example 36 includes the non-transitory computer-readable medium of any of Examples 31 to 35, wherein the instructions, when executed by the one or more processors, cause the one or more processors to: perform one or more object recognition operations based on the first image data and the second image data; and identify a common object that is included in the first image and the second image based on the one or more object recognition operations, wherein the one or more reflected objects include the common object.

Example 37 includes the non-transitory computer-readable medium of any of Examples 31 to 36, wherein the instructions, when executed by the one or more processors, cause the one or more processors to: perform one or more facial recognition operations based on the first image data and the second image data; and identify a common face that is included in the first image and the second image based on the one or more facial recognition operations, wherein the one or more reflected objects include the common face.

Example 38 includes the non-transitory computer-readable medium of any of Examples 31 to 37, wherein the instructions, when executed by the one or more processors, cause the one or more processors to perform on-device generation of the fill-in image data utilizing a trained artificial intelligence image generator.

Example 39 includes the non-transitory computer-readable medium of Example 38, wherein the instructions, when executed by the one or more processors, cause the one or more processors to provide a portion of the first image data as input to the trained artificial intelligence image generator to generate the fill-in image data, wherein the portion of the first image data corresponds to the region in the first image.

Example 40 includes the non-transitory computer-readable medium of Example 38, wherein the instructions, when executed by the one or more processors, cause the one or more processors to provide a portion of the first image data as input to the trained artificial intelligence image generator to generate the fill-in image data, wherein the portion of the first image data corresponds to a remainder of the first image that does not include the region.

Example 41 includes the non-transitory computer-readable medium of any of Examples 31 to 40, wherein the output image data represents an output image that includes a first plurality of pixels corresponding to a remainder of the first image that does not include the region and a second plurality of pixels corresponding to the fill-in image that are included within the region of the output image.

Example 42 includes the non-transitory computer-readable medium of Example 41, wherein the output image includes a third plurality of pixels corresponding to the fill-in image that are included in one or more locations adjacent to the region in the output image.

According to Example 43, an apparatus includes: means for obtaining first image data representing a first image captured in a first direction; means for obtaining second image data representing a second image captured in a second direction that is opposite to the first direction; means for identifying, based on the second image data, a region in the first image that includes one or more reflected objects; means for generating fill-in image data based on the first image data, the fill-in image data representing a fill-in image; and means for generating output image data, based on the first image data and the fill-in image data, that corresponds to the first image in which the region is replaced with the fill-in image.

Example 44 includes the apparatus of Example 43, and further includes means for performing, prior to identification of the region in the first image, one or more resizing operations on the second image data based on size information associated with the first image data.

Example 45 includes the apparatus of Example 43 or Example 44, and further includes means for performing, prior to identification of the region in the first image, one or more field of view (FOV) correction operations on the second image data based on FOV information.

Example 46 includes the apparatus of any of Examples 43 to 45, and further includes: means for generating a segmentation mask based on the second image; and means for performing a comparison of the segmentation mask and the first image, wherein the region in the first image is identified based on the segmentation mask.

Example 47 includes the apparatus of Example 46, and further includes: means for performing one or more resizing operations on the segmentation mask based on size information associated with the first image data; means for performing one or more field of view (FOV) correction operations on the segmentation mask based on FOV information; means for performing one or more transformation operations on the segmentation mask based on a focal length of the means for obtaining the first image data; or a combination thereof.

Example 48 includes the apparatus of any of Examples 43 to 47, and further includes: means for performing one or more object recognition operations based on the first image data and the second image data; and means for identifying a common object that is included in the first image and the second image based on the one or more object recognition operations, wherein the one or more reflected objects include the common object.

Example 49 includes the apparatus of any of Examples 43 to 48, and further includes: means for performing one or more facial recognition operations based on the first image data and the second image data; and means for identifying a common face that is included in the first image and the second image based on the one or more facial recognition operations, wherein the one or more reflected objects include the common face.

Example 50 includes the apparatus of any of Examples 43 to 49, and further includes means for performing on-device generation of the fill-in image data utilizing a trained artificial intelligence image generator.

Example 51 includes the apparatus of Example 50, and further includes means for providing a portion of the first image data as input to the trained artificial intelligence image generator to generate the fill-in image data, wherein the portion of the first image data corresponds to the region in the first image.

Example 52 includes the apparatus of Example 50, and further includes means for providing a portion of the first image data as input to the trained artificial intelligence image generator to generate the fill-in image data, wherein the portion of the first image data corresponds to a remainder of the first image that does not include the region.

Example 53 includes the apparatus of any of Examples 43 to 52, wherein the output image data represents an output image that includes a first plurality of pixels corresponding to a remainder of the first image that does not include the region and a second plurality of pixels corresponding to the fill-in image that are included within the region of the output image.

Example 54 includes the apparatus of Example 53, wherein the output image includes a third plurality of pixels corresponding to the fill-in image that are included in one or more locations adjacent to the region in the output image.

Those of skill would further appreciate that the various illustrative logical blocks, configurations, modules, circuits, and algorithm steps described in connection with the implementations and embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations and embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store first image data representing a first image captured by a first camera facing a first direction; and
one or more processors, coupled to the memory, wherein the one or more processors are configured to:
obtain second image data representing a second image captured by a second camera facing a second direction that is opposite to the first direction;
identify, based on the second image data, a region in the first image that includes one or more reflected objects;
generate fill-in image data based on the first image data, the fill-in image data representing a fill-in image; and
generate output image data, based on the first image data and the fill-in image data, that corresponds to the first image in which the region is replaced with the fill-in image.

2. The device of claim 1, wherein the one or more processors are configured to, prior to identification of the region in the first image, perform one or more resizing operations on the second image data based on size information associated with the first image data.

3. The device of claim 1, wherein the one or more processors are configured to, prior to identification of the region in the first image, perform one or more field of view (FOV) correction operations on the second image data based on FOV information associated with the first camera and the second camera.

4. The device of claim 1, wherein the one or more processors are configured to:
generate a segmentation mask based on the second image; and
perform a comparison of the segmentation mask and the first image, wherein the region in the first image is identified based on the segmentation mask.

5. The device of claim 4, wherein the one or more processors are configured to:
perform one or more resizing operations on the segmentation mask based on size information associated with the first image data;
perform one or more field of view (FOV) correction operations on the segmentation mask based on FOV information associated with the first camera and the second camera;
perform one or more transformation operations on the segmentation mask based on a focal length of the first camera; or
a combination thereof.

6. The device of claim 1, wherein the one or more processors are configured to:
perform one or more object recognition operations based on the first image data and the second image data; and
identify a common object that is included in the first image and the second image based on the one or more object recognition operations, wherein the one or more reflected objects include the common object.

7. The device of claim 1, wherein the one or more processors are configured to:
perform one or more facial recognition operations based on the first image data and the second image data; and
identify a common face that is included in the first image and the second image based on the one or more facial recognition operations, wherein the one or more reflected objects include the common face.

8. The device of claim 1, wherein the one or more processors are configured to perform on-device generation of the fill-in image data utilizing a trained artificial intelligence image generator.

9. The device of claim 8, wherein the one or more processors are configured to provide a portion of the first image data as input to the trained artificial intelligence image generator to generate the fill-in image data, wherein the portion of the first image data corresponds to the region in the first image.

10. The device of claim 8, wherein the one or more processors are configured to provide a portion of the first image data as input to the trained artificial intelligence image generator to generate the fill-in image data, wherein the portion of the first image data corresponds to a remainder of the first image that does not include the region.

11. The device of claim 1, wherein the output image data represents an output image that includes a first plurality of pixels corresponding to a remainder of the first image that does not include the region and a second plurality of pixels corresponding to the fill-in image that are included within the region of the output image.

12. The device of claim 11, wherein the output image includes a third plurality of pixels corresponding to the fill-in image that are included in one or more locations adjacent to the region in the output image.

13. The device of claim 1, further comprising:
the first camera coupled to the one or more processors and configured to generate the first image data, wherein the first camera is integrated in a back side of the device.

14. The device of claim 13, further comprising:
the second camera coupled to the one or more processors and configured to generate the second image data, wherein the second camera is integrated in a front side of the device.

15. The device of claim 1, further comprising:
a display coupled to the one or more processors and configured to display an output image based on the output image data.

16. The device of claim 1, further comprising:
a modem coupled to the one or more processors and configured to receive the first image data, the second image data, or a combination thereof.

17. The device of claim 1, wherein the one or more processors are integrated in at least one of a mobile phone, a tablet computer device, a wearable electronic device, or a camera device, and wherein the mobile phone, the tablet computer device, the wearable electronic device, or the camera device is configured to initiate display of an output image based on the output image data.

18. The device of claim 1, wherein the one or more processors are integrated in a vehicle that is configured to initiate display of an output image based on the output image data.

19. A method comprising:
obtaining, by a device, first image data representing a first image captured by a first camera facing a first direction;
obtaining, by the device, second image data representing a second image captured by a second camera facing a second direction that is opposite to the first direction;
identifying, by the device and based on the second image data, a region in the first image that includes one or more reflected objects;
generating, by the device, fill-in image data based on the first image data, the fill-in image data representing a fill-in image; and
generating, by the device, output image data, based on the first image data and the fill-in image data, that corresponds to the first image in which the region is replaced with the fill-in image.

20. A non-transitory computer-readable medium storing instructions that, when executed by one or more processors, cause the one or more processors to:
obtain first image data representing a first image captured by a first camera facing a first direction;
obtain second image data representing a second image captured by a second camera facing a second direction that is opposite to the first direction;
identify, based on the second image data, a region in the first image that includes one or more reflected objects;
generate fill-in image data based on the first image data, the fill-in image data representing a fill-in image; and
generate output image data, based on the first image data and the fill-in image data, that corresponds to the first image in which the region is replaced with the fill-in image.
